(19) United States
(12) Patent Application Publication
(10) Pub. No.: US 2016/0042519 A1
(43) Pub. Date: Feb. 11, 2016

(54) METHOD AND IMAGE PROCESSING DEVICE FOR EFFICIENT IMAGE DEPTH MAP GENERATION

(71) Applicants: NATIONAL TAIWAN UNIVERSITY, TAIPEI CITY 10617 (TW); LITE-ON TECHNOLOGY CORP., TAIPEI 11492 (TW)

(72) Inventors: JIUN-HUEI PROTY WU, TAIPEI CITY 10617 (TW); CHING-FENG CHENG, TAIPEI 11492 (TW)

(21) Appl. No.: 14/748,386

(22) Filed: Jun. 24, 2015

(30) Foreign Application Priority Data
Aug. 7, 2014 (TW) 103127056

(51) Int. Cl. G06T 7/00

(52) U.S. Cl. CPC G06T 7/0065; G06T 2207/20012; G06T 2207/10016; G06T 2207/10028

(57) ABSTRACT

In a method for generating image depth maps for image frames included in a video, an image processing device is configured to: acquire a full depth map of an n^{th} image frame of the video; find a to-be-processed region of an (n+m)^{th} image frame of the video, the to-be-processed region differing from a corresponding region of the n^{th} image frame of the video; process the to-be-processed region of the (n+m)^{th} image frame of the video for generating a partial depth map that corresponds to the to-be-processed region; and generate a full depth map of the (n+m)^{th} image frame of the video by using the partial depth map to replace a part of the full depth map of the n^{th} image frame of the video that corresponds in position to the partial depth map.

### CROSS-REFERENCE TO RELATED APPLICATION

This application claims priority of Taiwanese Application No. 103127056, filed on Aug. 7, 2014.

### FIELD OF THE INVENTION

The invention relates to a method and an image processing device that are configured to efficiently generate image depth maps for image frames included in a video.

### BACKGROUND OF THE INVENTION

Recently, movies and televisions have developed toward being presented in a three-dimensional (3D) video format. Conventionally, a 3D image on a virtual point of view is created by using a two-dimension (2D) image with an existed visual angle and a corresponding depth map. The depth map is a grey-scale image using a luminous intensity to represent a depth (i.e., a distance from the camera).

Conventionally, technology for generating a depth map requires acquiring a plurality of images having parallax thereamong for analyze. Additionally, each of the images is needed to be processed in its entirety, resulting a relatively slow processing speed. Therefore, when filming a video and a plurality of video frames need to be displayed per second, a processor with better performance must be employed (resulting in higher hardware costs), or a percentage of image frames of the video processed may need to be reduced (adversely affecting the quality of the subsequently generated 3D images).

### SUMMARY OF THE INVENTION

Therefore, an object of the present invention is to provide a method that enables efficient generation of image depth maps.

Accordingly, a method of this invention is for generating image depth maps for image frames included in a video, is to be implemented using an image processing device, and may include the following steps of:

(a) acquiring, by the image processing device, a full depth map of an n^{th} image frame of the video, wherein n is a positive integer;

(b) finding, using a difference spotting module of the image processing device, a to-be-processed region of an (n+m)^{th} image frame of the video, the to-be-processed region differing from a corresponding region of the n^{th} image frame of the video, wherein m is a positive integer;

(c) processing, using a depth map generating module of the image processing device, the to-be-processed region of the (n+m)^{th} image frame of the video for generating a partial depth map that corresponds to the to-be-processed region; and

(d) generating, using a depth map composing module of the image processing device, a full depth map of the (n+m)^{th} image frame of the video by using the partial depth map to replace a part of the full depth map of the n^{th} image frame of the video that corresponds in position to the partial depth map.

Another object of the present invention is to provide an image processing device that is configured to execute steps of the method of this invention.

Accordingly, an image processing device of this invention may include a storage medium and an image processor coupled to the storage medium. The storage medium stores a video therein. The video includes a plurality of consecutive image frames. The image processor is configured to:

acquire a full depth map of an n^{th} image frame of the video, wherein n is a positive integer;

find a to-be-processed region of an (n+m)^{th} image frame of the video, the to-be-processed region differing from a corresponding region of the n^{th} image frame of the video, wherein m is a positive integer;

process the to-be-processed region of the (n+m)^{th} image frame of the video for generating a partial depth map that corresponds to the to-be-processed region; and

generate a full depth map of the (n+m)^{th} image frame of the video by using the partial depth map to replace a part of the full depth map of the n^{th} image frame of the video that corresponds in position to the partial depth map.

### BRIEF DESCRIPTION OF THE DRAWINGS

Other features and advantages of the present invention will become apparent in the following detailed description of the embodiment with reference to the accompanying drawings, of which:

FIG. 1 is a block diagram of an image processing device of an embodiment according to the present invention;

FIG. 2 is a flow chart illustrating steps of a method of the embodiment according to the present invention;

FIG. 3 illustrates an n^{th} image frame and a full depth map thereof;

FIG. 4 illustrates an (n+1)^{th} image frame and a partial depth map thereof; and

FIG. 5 illustrates a full depth map being generated by using the partial depth map of FIG. 4 to replace a part of the full depth map of FIG. 3.

### DETAILED DESCRIPTION OF THE EMBODIMENT

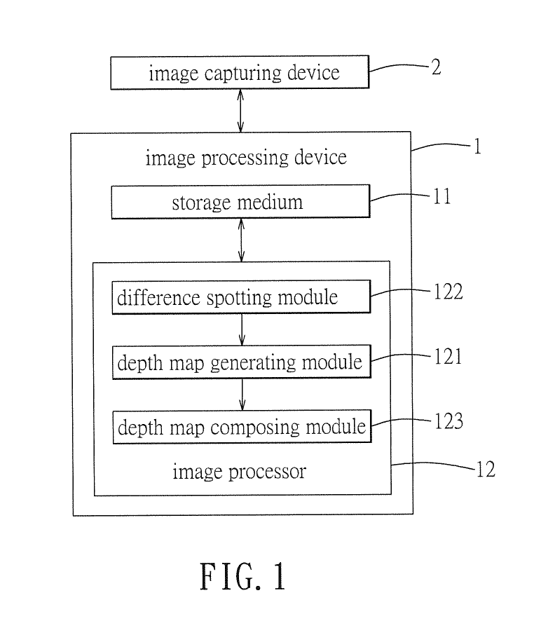

Referring to FIG. 1, an image processing device 1 of an embodiment according to the present invention is for processing images included in a video. In this embodiment, the image processing device 1 is coupled to an image capturing device 2 for receiving the video recorded thereby. In other embodiments, the image processing device 1 may be coupled to a computer device (not depicted in the drawings) that stores the video therein. The video may include a plurality of consecutive video frames to serve as image frames . The image processing device 1 may be integrated with the image capturing device 2, such as a light field camera or a video camera, or may be integrated with the computer device that is coupled to the image capturing device 2.

The image processing device 1 includes a storage medium 11 that stores the video received from the image capturing device 2/the computer device therein, and an image processor 12 coupled electrically to the storage medium 11.

The image processor 12 includes a depth map generating module 121, a difference spotting module 122 and a depth map composing module 123. In this embodiment, the depth map generating module 121, the difference spotting module 122 and the depth map composing module 123 are realized using software or firmware program that resides in the image processor 12 and that includes instructions for execution by the image processor 12 of the image processing device 1.

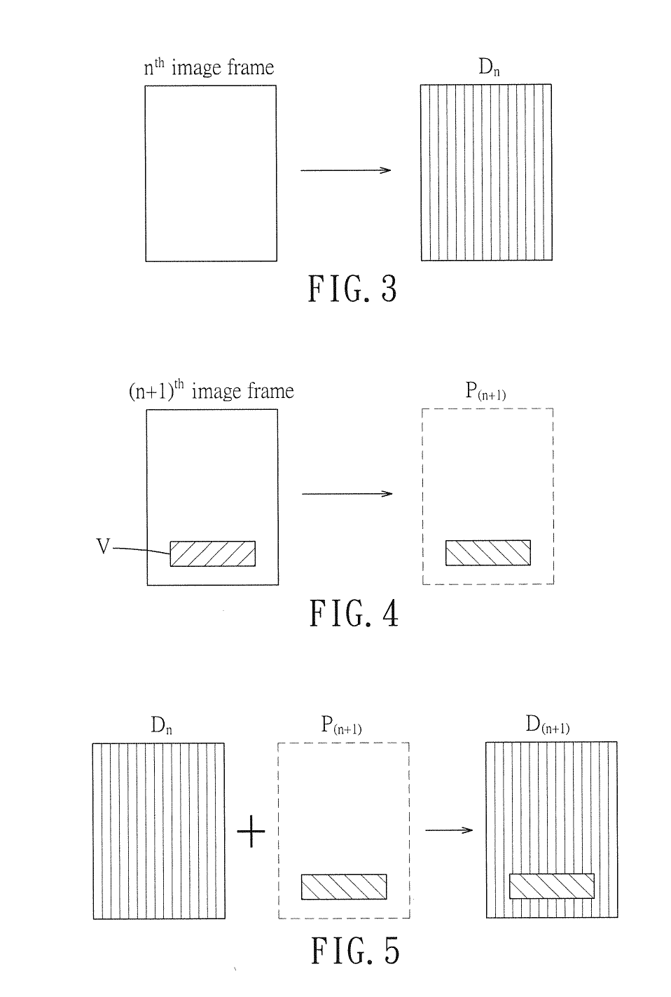

The depth map generating module 121 is configured to generate a full depth map (as illustrated in FIG. 3) and/or a partial depth map (as illustrated in FIG. 4) of a particular image frame of the video. The generated full depth map or the partial depth map may be then stored in the storage medium 11 for subsequent processing.

It is noted that a mechanism employed by the depth map generating module 121 in generating the full depth map and the partial depth map may be one similar to that disclosed in Taiwanese Patent Application No. 103110698, the entire disclosure of which is incorporated herein by reference.

The difference spotting module 122 is configured to compare two image frames of the video, and to find a region of one of the image frames of the video that differs from a corresponding region of the other one of the image frames of the video.

The difference spotting module 122 may determine whether the two image frames of the video are different by examining, pixel by pixel, the color pixel values of corresponding pixels on each of the two image frames of the video.

For example, when it is determined that a difference between color pixel values of a pixel on a first image frame and a pixel on a place of a second image frame corresponding in position to the first image frame is larger than a predetermined threshold, the difference spotting module 122 may deem the two pixels as “different”.

The depth map composing module 123 is configured to compose a full depth map of a particular image frame of the video by using a partial depth map of the particular image frame of the video to replace a part of the full depth map of another image frame of the video, the replaced part corresponding in position to the partial depth map.

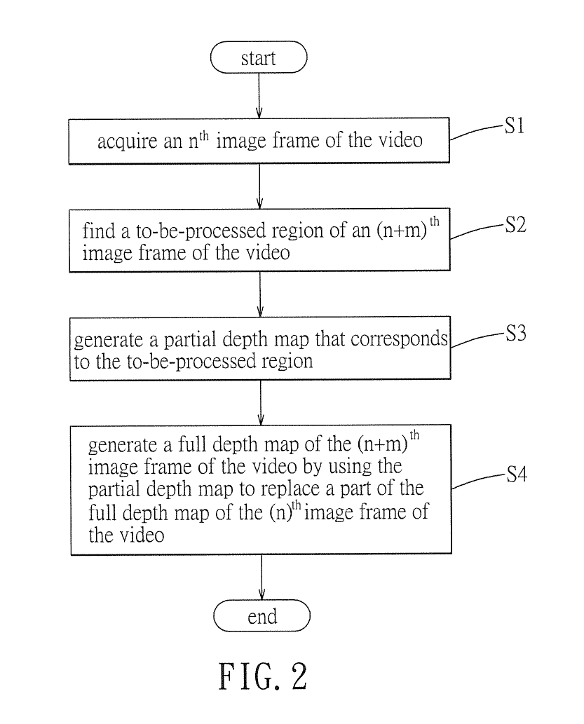

Referring to FIG. 2, the image processing device 1 is configured to perform a method according to the embodiment of the present invention.

In step S1, the image processor 12 of the image processing device 1 acquires an n^{th} image frame of the video stored in the storage medium 11. In this embodiment, n is a positive integer. Afterward, the depth map generating module 121 acquires a full depth map Dₙ of the n^{th} image frame of the video, as shown in FIG. 3.

In this embodiment, the depth map generating module 121 is configured to generate the full depth map Dₙ of the n^{th} image frame of the video by processing all regions of the n^{th} image frame of the video.

Afterward, the image processor 12 attempts to generate full depth maps for the subsequent image frames of the video. That is, the image processor 12 attempts to generate full depth maps for the (n+m)^{th} image frames of the video, where m is a positive integer. For example, for m=1, the (n+m)^{th} image frame of the video is one that immediately succeeds the n^{th} image frame of the video.

The difference spotting module 122 is configured to compare the n^{th}image frame of the video and the (n+1)^{th} image frame of the video to find differences therebetween.

When no significant difference is found (i.e., the n^{th} image frame of the video is substantially identical to the immediately succeeding image frame), the full depth map generated for the n^{th} image frame of the video may be taken directly as the full depth map of the (n+1)^{th} image frame of the video. Subsequently, in generating the full depth map of the (n+2)^{th} image frame of the video, the difference spotting module 122 compares the (n+1)^{th} image frame of the video and the (n+2)^{th} image frame of the video.

On the other hand, when some significant difference is found (e.g., between the (n)^{th} image frame of the video and the (n+1)^{th} image frame of the video), in step S2, the difference spotting module 122 finds a to-be-processed region of the (n+1)^{th} image frame of the video.

Specifically, the to-be-processed region of the (n+1)^{th} image frame of the video differs from a corresponding region of the (n)^{th} image frame of the video.

In step S3, the depth map generating module 123 processes the to-be-processed region V of the (n+1)^{th} image frame of the video, and generates a partial depth map P₍ₙ₊₁₎ that corresponds to the to-be-processed region, as best shown in FIG. 4.

In particular, the depth map generating module 123 is configured to process the to-be-processed region of the (n+m)^{th} image frame of the video and neighboring pixels of the to-be-processed region of the (n+m)^{th} image frame of the video for generating the partial depth map that corresponds to the to-be-processed region.

Then, in step S4, the depth map composing module 123 generates a full depth map D₍ₙ₊₁₎ of the (n+1)^{th} image frame of the video by using the partial depth map P₍ₙ₊₁₎ generated in step S3 to replace a part of the full depth map Dₙ of the (n)^{th} image frame of the video that corresponds in position to the partial depth map P₍ₙ₊₁₎, as best shown in FIG. 4.

In cases where n is larger than 1 (i.e., the n^{th} image frame is not the very first image frame of the video), the method may be carried out using a similar procedure.

Specifically, the image processor 12 may first acquire a full depth map of an (n−1)^{th} image frame of the video, and the n^{th} image frame of the video. The difference spotting module 122 then finds a to-be-processed region of the n^{th} image frame of the video, the to-be-processed region of the n^{th} image frame of the video differing from a corresponding region of the (n−1)^{th} image frame of the video.

Afterward, the depth map generating module 121 processes the to-be-processed region of the n^{th}image frame of the video for generating a partial depth map that corresponds to the to-be-processed region of the n^{th} image frame of the video. The depth map composing module 123 in turn generates the full depth map of the n^{th} image frame of the video by using the partial depth map thus generated to replace apart of the full depth map of the (n−1)^{th} image frame of the video that corresponds in position to the partial depth map thus generated.

One potential advantage of the method and the image processing device 1 according to the present invention is that, in a video, successive image frames typically only differ slightly from each other, or only differ from each other in a relatively small region. Therefore, it may not be cost-effective to process all regions for each of the image frames included in the video since most regions of a particular image frame may have been already processed in previous image frames.

By using the full depth map of a previous one of the image frames of the video as a base, the depth map generating module 123 is required to process only a part of a succeeding one of the image frames of the video rather than processing all regions. As a result, processing load of the depth map generating module 123 may be dramatically reduced. This may prove especially useful in processing videos with higher frame rates (e.g., a higher frames per second (FPS)) since the need to employ better hardware and/or reduce the percentage of the image frames to be processed are eliminated.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for generating image depth maps for image frames included in a video, said method to be implemented using an image processing device and comprising:
(a) acquiring, by the image processing device, a full depth map of an n^{th} image frame of the video, wherein n is a positive integer;
(b) finding, using a difference spotting module of the image processing device, a to-be-processed region of an (n+m)^{th} image frame of the video, the to-be-processed region differing from a corresponding region of the n^{th} image frame of the video, wherein m is a positive integer;
(c) processing, using a depth map generating module of the image processing device, the to-be-processed region of the (n+m)^{th} image frame of the video for generating a partial depth map that corresponds to the to-be-processed region; and
(d) generating, using a depth map composing module of the image processing device, a full depth map of the (n+m)^{th} image frame of the video by using the partial depth map to replace a part of the full depth map of the n^{th} image frame of the video that corresponds in position to the partial depth map.

2. The method of claim 1, wherein, in step (a), the depth map generating module of the image processing device generates the full depth map of the n^{th} image frame of the video by processing all regions of the n^{th} image frame of the video.

3. The method of claim 1, wherein step (a) includes the following sub-steps of:
(a0) acquiring, by the image processing device, a full depth map of an (n−1)^{th} image frame of the video;
(a1) finding, using the difference spotting module, a to-be-processed region of the n^{th} image frame of the video, the to-be-processed region of the n^{th} image frame of the video differing from a corresponding region of the (n−1)^{th} image frame of the video;
(a2) processing, using the depth map generating module, the to-be-processed region of the n^{th} image frame of the video for generating a partial depth map that corresponds to the to-be-processed region of the n^{th} image frame of the video; and
(a3) generating, using the depth map composing module, the full depth map of the n^{th} image frame of the video by using the partial depth map generated in sub-step (a2) to replace a part of the full depth map of the (n−1)^{th} image frame of the video that corresponds in position to the partial depth map generated in sub-step (a2).

4. The method of claim 1, wherein, in step (c), the depth map generating module processes the to-be-processed region of the (n+m)^{th} image frame of the video and neighboring pixels of the to-be-processed region of the (n+m)^{th} image frame of the video for generating the partial depth map that corresponds to the to-be-processed region.

5. The method of claim 1, wherein the difference spotting module, the depth map generating module and the depth map composing module are realized using software or firmware program that resides in a storage medium and that includes instructions for execution by an image processor of the image processing device.

6. An image processing device comprising a storage medium and an image processor coupled to said storage medium, said storage medium storing a video therein, the video including a plurality of consecutive image frames, wherein said image processor is configured to:
acquire a full depth map of an n^{th} image frame of the video, wherein n is a positive integer;
find a to-be-processed region of an (n+m)^{th} image frame of the video, the to-be-processed region differing from a corresponding region of the n^{th} image frame of the video, wherein m is a positive integer;
process the to-be-processed region of the (n+m)^{th} image frame of the video for generating a partial depth map that corresponds to the to-be-processed region; and
generate a full depth map of the (n+m)^{th} image frame of the video by using the partial depth map to replace a part of the full depth map of the n^{th} image frame of the video that corresponds in position to the partial depth map.

7. The image processing device of claim 6, wherein said image processor is configured to generate the full depth map of the n^{th} image frame of the video by processing all regions of the n^{th} image frame of the video.

8. The image processing device of claim 6, wherein said image processor is configured to generate the full depth map of the n^{th} image frame of the video by:
acquiring a full depth map of an (n−1)^{th} image frame of the video;
finding a to-be-processed region of the n^{th} image frame of the video, the to-be-processed region of the n^{th} image frame of the video differing from a corresponding region of the (n−1)^{th} image frame of the video;
processing the to-be-processed region of the n^{th} image frame of the video for generating a partial depth map that corresponds to the to-be-processed region of the n^{th} image frame of the video; and
generating the full depth map of the n^{th} image frame of the video by using the partial depth map thus generated to replace apart of the full depth map of the (n−1)^{th} image frame of the video that corresponds in position to the partial depth map.

9. The image processing device of claim 6, wherein said image processor is configured to process the to-be-processed region of the (n+m)^{th} image frame of the video and neighboring pixels of the to-be-processed region of the (n+m)^{th} image frame of the video for generating the partial depth map that corresponds to the to-be-processed region.

10. The image processing device of claim 6, wherein said image processor includes:
a depth map generating module configured to acquire the full depth map of the n^{th} image frame of the video and to generate the partial depth map of the (n+m)^{th} image frame of the video;
a difference spotting module configured to find the to-be-processed region of the (n+m)^{th} image frame of the video; and
a depth map composing module configured to generate the full depth map of the (n+m)^{th} image frame of the video.
